(19) United States
(12) Patent Application Publication
(10) Pub. No.: US 2006/0096462 A1
(43) Pub. Date: May 11, 2006

(54) Disposable beverage cup with water soluble beverage fixture

(76) Inventor: James Kennoway Allan, Hong Kong SAR (CN)

Correspondence Address: ALIX YALE & RISTAS LLP, 750 MAIN STREET, SUITE 1400, HARTFORD, CT, 06103, US

(21) Appl. No.: 10/984,151

(22) Filed: Nov. 9, 2004

(51) Int. Cl. A23L 1/00

(52) U.S. Cl. 99/275

(57) ABSTRACT

A disposable cup has a floor to which there is affixed a cake of water-soluble flavoursome material to dissolve when water is added to the cup.

### BACKGROUND OF THE INVENTION

The present invention relates to disposable cups of the type that might be used for takeaway coffee for example. More particularly, although not exclusively, the invention relates to a disposable beverage cup having a consolidated beverage “cake” affixed internally to its floor, so that hot water can simply be added to dissolve the beverage cake prior to being imbibed.

It is known of course mix instant coffee with hot water in a disposable cup. Milk, milk powder or coffee creamer and/or sugar are added to taste. When people are “on the go” so to speak, it can be a cumbersome operation to add all the desired ingredients from separate jars for example. Where time is of the essence at fast food outlets, railway stations and airports for example, such delays are best avoided.

### OBJECTS OF THE INVENTION

It is an object of the present invention to provide a cost-effective, disposable fast beverage cup having a mixture of water-soluble ingredients affixed internally of the cup until dissolved by adding water thereto.

### DISCLOSURE OF THE INVENTION

There is disclosed herein a disposable cup having a floor to which there is affixed a cake of water-soluble flavoursome material to dissolve when water is added to the cup.

The cake would typically comprise consolidated ingredient(s) selected from the group consisting of: instant coffee; milk (or coffee creamer); sugar (or artificial sweetener); a binder.

Preferably, the cake is adhered to the floor with a edible adhesive.

Preferably, the cup comprises a wall that extends beneath the floor to define a cavity, and wherein the cavity is deeper than the cake—thus enabling nesting of the cup with another such cup without the cake of said another cup engaging the floor of the first said cup which would otherwise limit the stacking density of a plurality of nested cups.

Preferably, there is an annular void between the cake and the cup wall to receive the bottom edge of the wall of a cup stacked therein.

Definition

As used herein, the word “cake” is intended to mean a unitary mass of one or more ingredients. The ingredients might be from powdered sources and/or liquid sources. The unitary mass might be soft or hard, and might typically be porous to enable the ingress of water thereto to enable the mass to deconsolidate when desired. The mass might be consolidated or lightly packed and would be generally self-supportive.

### BRIEF DESCRIPTION OF THE DRAWINGS

Preferred forms of the present invention will now be described by way of example with reference to the accompanying drawings, wherein:

FIG. 1 is a schematic cross-sectional elevation of a pair of nested paper cups—each paper cup having a cake of ingredients affixed to its floor, and

FIG. 2 is a schematic perspective illustration of a plastic cup having a cake of ingredients affixed to its floor.

### DESCRIPTION OF THE PREFERRED EMBODIMENTS

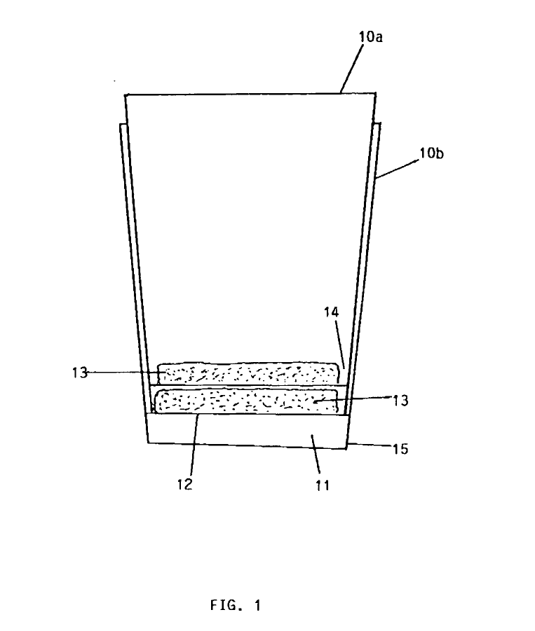

In FIG. 1 of the accompanying drawings there is depicted schematically a pair of paper cups 10a and 10b nested one within the other. Each cup comprises a floor 12 and a sub-floor cavity 11. The basic structure of such cups is known in the art and might be wax-impregnated or otherwise waterproofed. Affixed to the top surface of each floor 12 is a “cake” 13 of beverage ingredients. These ingredients would typically include coffee, coffee creamer and sugar. However, the cake might be a consolidated mass of any one or more of the above ingredients, or any one or more ingredients such as chocolate, tea leaves, powdered milk, soup ingredients, thickeners, or any other ingredients that might be mixed with hot or cold water to form a liquid mixture that might be imbibed. The cake is of substantially smaller volume than the overall volume of the cup—thus leaving a larger volume of air within the cup. This volume of air above the cake would be displaced by water when water is added to dissolve the cake.

Depending on the particular ingredients, a binding agent may or may not have to be added to form the cake. For example, if sugar were one of the ingredients, it could act as a binding agent. Otherwise, an inert-flavoured and certainly edible binding additive could be used. For example, a suitable binding agent might include gelatine.

The cake should be affixed to the floor 12. To this end, the ingredients themselves might act as an adhesive, or an inert-flavoured and certainly edible adhesive could be used either as a layer between the cake and the floor. As a further alternative, the binding agent might act as an adhesive between the cake and the cup floor

There is an annulus 14 around the cake 13 to receive the bottom edge 15 of an upper adjacent cup in a nested stack of cups. As can be seen from the drawing, the cake 13 does not diminish the stacking density of the nested cups, because its height in less than the depth of the cavity 12.

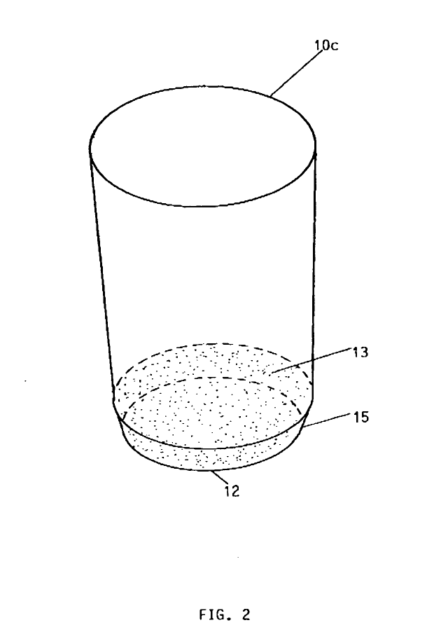

A further embodiment is depicted in FIG. 2. This embodiment comprises a disposable cup 10c that would typically be formed of plastics material (typically by a blow moulding process). Such cups comprise a narrowed bottom portion 15. The cake 13 simply occupies or partly occupies the width of the narrowed bottom portion 15 and is adhered to the floor 12 (and/or the bottom portion of the cup wall) by adhesive means of similar to those described above. Alternatively, the cake might be dimensioned slightly wider than the natural width of the cup bottom so as to fit tightly therein until dissolved.

Each cup would be labelled with its ingredients to assist selection by a customer. For example, if the cake comprised instant coffee, sugar and whitener/creamer, it might be labelled “Sweetened Coffee with Milk”. If the cake was just instant coffee and nothing else, then the label might read “Black Unsweetened Coffee” or something similar.

It should be appreciated that modifications and alterations obvious to those skilled in the art are not to be considered as beyond the scope of the present invention. For examples instead of mixing the ingredients into a single cake, separate segments of individual ingredients might be provided.

1. A disposable cup having a floor to which there is affixed a cake of water-soluble flavoursome material to dissolve when water is added to the cup.

2. The cup of claim 1, wherein the cake comprises consolidated ingredients selected from the group consisting of: instant coffee; milk; coffee creamer; sugar; artificial sweetener; and a binder.

3. The cup of claim 1, wherein the cake is adhered to the floor with an edible adhesive.

4. The cup of claim 1, comprising a wall that extends beneath the floor to define a cavity, and wherein the cavity is deeper than the cake.

5. The cup of claim 4, comprising an annular void between the cake and the cup wall.
